(19) United States
(12) Patent Application Publication
(10) Pub. No.: US 2002/0141931 A1
(43) Pub. Date: Oct. 3, 2002

(54) Methods of making carbon foams

(76) Inventor: Steven R. Reznek, Concord, MA (US)

Correspondence Address: William F. Dee, Esq., CABOT CORPORATION, Law Department, 157 Concord Road, Billerica, MA, 01821, US

(21) Appl. No.: 09/825,582

(22) Filed: Apr. 3, 2001

(51) Int. Cl. H01M 4/96; H01M 4/58; C01B 31/02

(52) U.S. Cl. 423/445 R; 429/40; 429/231.8

(57) ABSTRACT

A method of making carbon foam is disclosed and involves pyrolizing at least one pyrolizable material in the presence of a sufficient amount of at least oxidizing source. The pyrolizable material or its decomposition products may provide the fuel or a separate fuel can be used. The pyrolizable material and oxidizing source and optionally a fuel source can be introduced in any order or in any combination. The resulting carbon foam made by this process is also described. Furthermore, the carbon foam made by this process can be used in a variety of end use applications including electrodes, thermal insulation material, polymers, elastomers, and the like.

### BACKGROUND OF THE INVENTION

The present invention relates to carbon foams and methods of making carbon foams as well as their use in a variety of products, such as insulation materials and capacitors and fillers for polymers or elastomers.

Carbon aerogels have been used in a wide variety of applications, including thermal insulation, conducting fillers for polymers or plastics, electrodes, and electrochemical cells. Carbon aerogels which have high surface areas and high DBP values are desirable in many of these and other applications.

Various methods are known to make carbon aerogels including using pitch, using organic gels with a catalyst and reacting the mixture, using sol-gel polymerization to form highly cross linked networks of high surface area foam and dissolving a polyacrylonitrile in a heated solution with at least one alkali metal halide in a solvent to eventually form a liquid gel. The liquid gel is then heated wherein the solvent is removed along with the dissolved alkali metal halide to provide a porous form consisting essentially of polyacrylonitrile wherein the porous form is then cured at elevated temperatures to carbonize the polyacrylonitrile to form the carbon foam.

While such methods are useful, there is always a desire in the industry to develop other less expensive methods of making carbon foams which preferably lead to greater flexibility in making foams having higher surface areas as well as high structure.

### SUMMARY OF THE PRESENT INVENTION

A feature of the present invention is to provide carbon foams.

Another feature of the present invention is to provide carbon foams preferably having high surface areas as well as high structure.

An additional feature of the present invention is to provide inexpensive methods of making carbon foams.

Still, another feature of the present invention is to incorporate the polymer foams into such applications as thermal insulation, conducting fillers, electrodes, reinforcing fillers, and the like.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages, and in accordance with the purposes of the present invention, as embodied and broadly described herein, the present invention relates to a method of making carbon foam which involves rapid pyrolizing at least one pyrolizable material in the presence of a sufficient amount of at least one oxidizing source to obtain the carbon foam. The pyrolizable material may comprise the fuel source or a separate source may be used.

The present invention further relates to carbon foam made by the above-described method.

The present invention further relates to carbon foam having cells bordered by thin sheets or windows and/or struts. Typically the cells are not closed, but have openings between them. Because the foam can be rigid, pieces of the foam can be broken off, and material can consist of both the foam particles and their fragments.

It is to be understood that both the foregoing general description and the following detailed description are exemplary and explanatory only and are intended to provide a further explanation of the present invention, as claimed.

### DETAILED DESCRIPTION OF THE PRESENT INVENTION

The present invention relates to carbon foams and methods of making these carbon foams. The present invention further relates to the use of these carbon foams in a variety of end-use applications.

The carbon foam of the present invention is preferably made by pyrolizing at least one pyrolizable material in the presence of a sufficient amount of at least one fuel source and at least one oxidizing source. The pyrolizable material or the products of the pyrolisis may provide the fuel source and/or a separate fuel source may be used. This carbon foam can then be used in its foam state or can be reduced into pieces to form particles which preferably are highly structured.

In more detail, and with reference to the above-described method, the pyrolizing material or substance is preferably an organic substance such as an organic compound. Examples include, but are not limited to, coal, hydrocarbons, and carbohydrates. Essentially, the substance used is a substance which will pyrolize instead of evaporate when heated. A preferred pyrolizable substance is sugar, cellulose compounds, coal, and the like. Other examples include, but are not limited to, hydrocarbons and polymers and derivatives thereof.

The fuel source that is used in the present invention can be any fuel source, such as a gas, liquid, or solid or combinations thereof. As stated, the pyrolizable material can serve as the fuel source and/or at least one fuel source other than the pyrolizable material can be used. Examples of suitable fuel sources include, but are not limited to, natural gas or hydrocarbon (e.g., oil), or mixtures of two or more materials. An example of such a mixture is a suspension of ground coal in oil.

The oxidizing source can also be in any state, such as a gas, solid, or a liquid, or combinations thereof. Preferably, the oxidizing component is in the form of a gas and is preferably air or oxygen or both.

The amount of each component in the process can be varied depending upon the desired structure of the carbon foam as well as the desired surface area of the carbon foam. For purposes of the present invention, the heat generated during the method should be sufficient to at least partially pyrolize the pyrolizable material. The oxidizing source should be sufficient to at least partially combust the fuel but the amount of oxidizing source should be controlled such that the pyrolizable material does not completely combust or burn the pyrolizable material. The amount of oxidizing material needed is in the range of 0.05 to 0.75 of the theoretical amount needed to completely burn all of the fuel and combustible material. In the case where a separate fuel is used, the amount of fuel is such that the fuel combustion consumes between 0 and 100% of the oxidizing material.

The preferred rapid pyrolizing can occur in any device conventionally used for combustion such as a carbon black reactor or other suitable combustion chamber.

Examples of pyrolizing temperature ranges include, but are not limited to, from about 200° C. to about 1600° C., and more preferably from about 400° C. to about 1600° C. Certainly, other temperature ranges are possible depending upon the type of pyrolizable substance used. Once the pyrolizable substance is determined, determining the necessary pyrolizing temperature is within one skilled in the art in view of the present application and routine experimentation.

In following the method of the present invention, a variety of orders can be followed with respect to the introduction of the various components. For instance, the fuel source can be used as a carrier stream to introduce the pyrolizable material into the combustion chamber. Likewise, the oxidizing source can be used as a carrier stream to introduce the pyrolizable material. For instance, when the fuel source is a gas stream such as natural gas, a suspension of finely ground particles of a pyrolizable material, such as coal, can be introduced by this gas stream into the combustion chamber for purposes of the pyrolizing step. Examples of alternative embodiments include the introduction of the pyrolizable material into a combustion chamber wherein the fuel source and/or the oxidizing source are already present in the combustion chamber. In this embodiment, the fuel source and the oxidizing can be pre-ignited prior to introduction of the pyrolizable material which can be introduced by itself or by a carrier gas or liquid which can be the same or different from the fuel source and/or oxidizing source or can be a neutral source such as nitrogen gas and the like. If the fuel source and oxidizing source are pre-ignited, the pyrolizable material can be, for instance, injected into the flame for purposes of the pyrolizing step. Mixtures of solid and liquid materials such as coal in oil can be used to facilitate the injection. As another embodiment, the fuel source, oxidizing source, and the pyrolizable material can be mixed all together prior to introduction into the combustion chamber, or they can be introduced sequentially, or in any other combination or order as along as the pyrolizable material is at least partially pyrolized to form carbon foam.

In other embodiments of the present invention, additional fuel sources and/or oxidizing sources and/or additional pyrolizable material, which can be the same or different from the components already present, can be added. For instance, a fuel source and an oxidizing source can be present in the chamber and the pyrolizable material can be introduced by means of a carrier stream which can also be a second fuel source and/or an oxidizing source. In addition, a fuel source and an oxidizing source can be introduced into a chamber along with pyrolizable material and then additional amounts of a fuel source or an oxidizing source or pyrolizable material, which can be the same or different from the original fuel source, oxidizing source, and/or pyrolizable material can be added. Thus, various modifications can be made to the method of the present invention to meet the desired parameters of the carbon foam.

Any means of introducing a liquid or gas stream can be used for purposes of the present invention in introducing the fuel source and the oxidizing source. Similarly, any means that are conventional with respect to the introduction of particles into a combustion chamber such as by a carrier gas or the like can be used for purposes of the present invention.

After the pyrolizing step, the carbon foam that is formed can be recovered by any conventional technique used to recover particles from a pyrolization including, but not limited to, cyclone separators, fabric filters, and the like.

The carbon foam of the present invention can be subsequently chemically modified or surface treated using a variety of techniques such as the attachment of organic groups onto the surface of the carbon foam. Such techniques and groups include, but are not limited to, these described U.S. Pat. Nos. 5,900,029; 5,895,522; 5,885,335; 5,851,280; 5,837,045; 5,803,959; 5,672,198; 5,571,311; 5,630,868; 5,707,432; 5,803,959; 5,554,739; 5,698,016; 5,713,988; WO 96/18688; WO 97/47697; WO 97/47699, and U.S. patent application Ser. Nos. 09/317,287; 60/116,500; 60/135,558; 60/163,716; and 60/163,857; where all are incorporated herein in their entireties by reference.

The carbon foam, once formed, can be used as any other conventional carbon foam. For instance, the carbon foam can be used in a manner as described in U.S. Pat. Nos. 5,300,272; 6,033,506; 5,945,084; and 5,476,878, all incorporated in their entireties by reference herein.

The carbon foam can, if desired, be reduced to fragments and/or particles. The reduction of the carbon foam can be achieved by any technique such as grinding the carbon foam into highly structured particles and/or fragments. The grounded carbon foam can be used as filler or any other use for carbon based particles.

As indicated above, the carbon foams can be used in a wide variety of application, including thermal insulation, reinforcement applications, fillers for elastomers or polymers such as plastics, electrodes in electrochemical cells or supercapacitors, and the like. The manner and amount of the carbon foam used in each of these applications would be conventional and known to those skilled in the art in view of the present application and the conventional technology of using carbon foam in these applications.

The carbon foam formed can be used in various end use applications, such as in polymer compounds, elastomer compounds, thermal insulating materials, electrodes, capacitors, fuel cells, batteries, and the like. The carbon foam can be used in lieu of conventional fillers, pigments, or particles that are used in such end use applications.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of making carbon foam comprising pyrolizing a mixture comprising at least one pyrolizable material in the presence of at least one oxidizing source and optionally at least one fuel source other than said pyrolizable material.

2. The method of claim 1, wherein said at least one fuel source is present.

3. The method of claim 1, wherein said pyrolizable substance comprises coal.

4. The method of claim 1, wherein said pyrolizable substance is an organic compound.

5. The method of claim 1, wherein said pyrolizable substance comprises at least one carbohydrate.

6. The method of claim 1, wherein said pyrolizable substance is sugar or cellulose.

7. The method of claim 2, wherein said fuel source is a liquid or gas or combination thereof.

8. The method of claim 2, wherein said fuel source is natural gas.

9. The method of claim 2, wherein said fuel source is a hydrocarbon containing material.

10. The method of claim 1, wherein said oxidizing source is air, oxygen, or both.

11. The method of claim 1, wherein said oxidizing material is present in an amount which is between 0.05 and 0.75 of the amount needed to combust completely the pyrolizable material and fuel; and the fuel is present in an amount such that its complete combustion consumes between 0 and 100% of the oxidizable material.

12. The method of claim 1, wherein said pyrolizable material, fuel source when present, and oxidizing source are introduced sequentially in any order.

13. The method of claim 1, wherein said pyrolizable material, fuel source, and oxidizing source are added as a mixture.

14. The method of claim 1, wherein said at least one pyrolizable material is introduced into a combustion chamber by being dispersed in said fuel source when present or said oxidizing source or both.

15. The method of claim 14, wherein said fuel source is a liquid.

16. The method of claim 14, wherein said fuel source is a gas.

17. The method of claim 2, wherein said fuel source and said oxidizing source are introduced into a combustion chamber prior the introduction of at least one pyrolizable material and wherein said fuel source and oxidizing source are ignited prior to introducing said at least one pyrolizable material into said chamber.

18. The method of claim 1, wherein said at least pyrolizable material is introduced by being dispersed in a carrier stream.

19. The method of claim 18, wherein said carrier stream is an inert gas.

20. The method of claim 18, wherein said carrier gas is a fuel source or an oxidizing source or both.

21. The method of claim 1, wherein said pyrolizing occurs at a temperature of from about 300° C. to about 1600° C.

22. Carbon foam formed by the method of claim 1.

23. Carbon foam formed by the method of claim 2.

24. The carbon foam of claim 22, said carbon form having cells bordered by thin sheets, windows, struts, or combinations thereof.

25. The carbon foam of claim 23, said carbon form having cells bordered by thin sheets, windows, struts, or combinations thereof.

26. The carbon foam of claim 22, wherein said cells have openings between them.

27. The carbon foam of claim 22, wherein said carbon foam is rigid.

28. A thermal insulating material comprising the carbon foam of claim 22.

29. A polymer compound comprising the carbon foam of claim 22, or fragments thereof.

30. An electrode comprising the carbon foam of claim 22.

31. A capacitor electrode comprising the carbon foam of claim 22.

32. An elastomer compound comprising the carbon foam of claim 22, or fragments thereof.

33. A fuel cell comprising the carbon foam of claim 22.

34. A battery electrode comprising the carbon foam of claim 22.

35. The method of claim 1, wherein said pyrolizable substance comprises at least one hydrocarbon containing material.
